(19) United States
(12) Patent Application Publication
(10) Pub. No.: US 2006/0079395 A1
(43) Pub. Date: Apr. 13, 2006

(54) Catalyst systems for polycondensation reactions

(76) Inventors: Jens-Peter Wiegner, Halle (DE); Dietmar Runkel, Merseburg (DE); Volkmar Voerckel, Merseburg (DE); Gunter Feix, Halle (DE); Hans Staeuber, Wollerau (CH)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/513,183

(22) PCT Filed: Apr. 28, 2003
(86) PCT No.: PCT/US03/13132

§ 371 Date: Nov. 1, 2004

(30) Foreign Application Priority Data
May 9, 2002 (US) 60379676

(51) Int. Cl. B01J 31/00

(52) U.S. Cl. 502/150; 502/350; 502/152; 502/155; 502/162

(57) ABSTRACT

The invention concerns new catalyst systems for the synthesis of polyesters, for instance for the manufacture of polyethylene terephthalate and its copolyesters. The catalyst system according to the invention consists of an antimony or germanium compound, a heterogeneous catalyst component and an ester of phosphoric acid or of phosphorous acid as stabilizer. The polycondensation rate both in the liquid phase and in solid phase polycondensation (solid state) can be increased by 30-100 percent with the smallest additions of the heterogeneous component.

The invention concerns new catalyst systems for the synthesis of polyesters, for instance the manufacture of polyethylene terephthalate and its copolyesters.

The synthesis of polyesters such as polyethylene terephthalate requires the use of catalysts in the polycondensation steps (melt phase and possibly solid state). A number of patents can be found in the literature that describe the use of catalytically active substances. Today, antimony and titanium compounds are used in particular in industry, in the manufacture of polyethylene terephthalate. This is also reflected in the numerous patents that describe the use of such compounds. Polyester-soluble antimony compounds are described as polycondensation catalysts in U.S. Pat. Nos. 3,965,071, 3,998,793, 4,039,515, 4,116,942, 4,133,800, 4,454,312, 5,750,635 and 5,780,575. Modified antimony derivatives (stabilized by substances with double bonds to prevent reduction to metallic antimony) are for instance the subject of patents U.S. Pat. No. 4,067,856, U.S. Pat. No. 4,067,857 and U.S. Pat. No. 4,130,552. Antimony salts of trimellithic acid esters are also used as catalysts in the manufacture of polyethylene terephthalate (U.S. Pat. No. 5,478,796).

A combination of sulfonic acid, titanate and antimony (or germanium) compounds is the object of U.S. Pat. No. 5,905,136. U.S. Pat. Nos. 5,286,836 and 5,714,570 mention combinations of antimony and titanium compounds as catalytically active. U.S. Pat. No. 6,372,879 must also be mentioned in this context. The synergistic effects of catalyst systems described in this patent appear when complex titanium/antimony/(oxalate) systems are used. Germanium compounds have also been described as catalysts for the polycondensation reaction (U.S. Pat. No. 5,378,796, U.S. Pat. No. 5,830,981, U.S. Pat. No. 5,837,786 and U.S. Pat. No. 5,837,800). However, for economic reasons the use of these compounds has not become widespread.

The combination of several metal compounds is described in U.S. Pat. No. 4,122,107 (Sb/Zn(Ca,Mn); U.S. Pat. No. 4,356,299, U.S. Pat. No. 4,501,878 and U.S. Pat. No. 5,286,836 (Ti/Sb); U.S. Pat. No. 5,565,545 and U.S. Pat. No. 5,644,019 (Sb/Ge); U.S. Pat. No. 5,608,032 and U.S. Pat. No. 5,623,047 (Sb/Co(Mg,Zn,Mn,Pb). At least one component of these complex catalysts is a classic” polycondensation catalyst, either antimony, titanium or germanium. In the most favorable case, the activity of these systems lies in the range of activity of a pure antimony compound.

Finely dispersed titanates are the object of U.S. Pat. No. 5,656,716.

Jointly precipitated titanium and silicon compounds and titanium and zirconium compounds are described in U.S. Pat. Nos. 5,684,116 and 5,789,528.

A polycondensation catalyst based on zeolites (alkali or alkaline earth-modified alumino-silicate) is protected by U.S. Pat. No. 5,733,969.

The object of patent WO 01/42335 is the use of hydrotalcites as effective catalysts for polycondensation reactions. These compounds exhibit a higher activity than for instance antimony compounds, particularly in the liquid phase (melt phase).

The use of antimony compounds is especially preferred, since the selectivity of the catalyzed polycondensation reactions is highest and the reaction rate of the polycondensation is adequate. The content in undesirable degradation products, such as acetaldehyde, is lowest in the processed polyester, compared to titanium compounds, for instance.

However, the use of antimony compounds such as antimony oxide, antimony acetate or antimony glycolate as catalysts for polycondensation reactions is permissible only within defined limits, since these substances are physiologically objectionable, as heavy metal compounds. For this reason it is not possible to increase the reaction rate of the polycondensation reactions indefinitely by increasing the catalyst concentration. Another cause for the economically unsatisfactory reaction rate is the fact that the rate of the two reaction steps (melt phase and solid state) depends not only the temperature, but also very strongly on the diffusion of volatile reaction products, such as ethylene glycol.

The invention is based on the task of developing a catalyst system for the synthesis of polyesters, in particular poly(ethylene terephthalate) and its copolyesters that at clearly increased catalytic activity, does not affect or affects only minimally the application-related properties of the polyester. In addition, the use of these systems should be physiologically safe.

It was very surprisingly found that using a combination of certain in part already known polycondensation catalysts, the reaction rates in the melt phase and in the solid state during the manufacture of polyethylene terephthalate could be clearly increased, without negatively affecting the quality of the polyester. These new catalyst systems according to the invention consist of:
a) a classic polycondensation catalyst of antimony, germanium or titanium compounds such as antimony acetate, antimony oxide, antimony glycolate, germanium oxide or tetrabutyl titanate,
b) a second, heterogeneous catalyst such as hydrotalcite or hydrotalcite-like compounds of general formula
   [M(II)₁₋ₓM(III)ₓ(OH)₂]^{x+}(Aⁿ⁻_{x/n}).mH₂O
   in which M(II) stands for divalent metals, in particular magnesium, zinc, nickel, copper,
   iron(II) or cobalt(II); M(III) for trivalent metals, such as aluminum or iron(III) and
   A for anions such as carbonates, borates or titanyl compounds, and
c) a stabilizer, preferably an ester of phosphoric acid or phosphorous or phosphonic acid.

It was surprisingly found that combinations of these catalysts exhibit synergistic effects. The polycondensation rate in the liquid phase at temperatures of 250-300° C. can be increased by 30->10 percent with the smallest additions of the heterogeneous component (approx. 5-50 ppm). The situation is similar in solid phase polycondensation (solid state) at temperatures of 180-230° C. For additions of 5-50 ppm of the heterogeneous component, only little catalytically active in the solid state, here too the reaction rate of this polycondensation reaction can be increased by up to 50 percent

These new catalyst systems are preferably used with the following composition:
antimony or germanium compounds 50-1000 ppm, heterogeneous catalyst 1-100 ppm (depending on particle size) and esters of phosphoric or phosphorous acids, 5-500 ppm. The heterogeneous catalysts are preferably used with particle sizes between 50 nm and approx. 3 μm. Systems with a ratio of homogeneous/heterogeneous-acting catalyst of from 100:1 to 1:5, preferably of 80:1 to 5:1, are especially preferred.

The invention will be elucidated below by means of implementation examples. The intrinsic viscosity (IV) of the synthesized polyesters was determined on an instrument of the Schott company (AVSPro), on 250 mg polyester dissolved in 50 ml phenol/dichlorobenzene (1:1).

The acetaldehyde determination in the extruded products used the following procedure:
The PET material was precooled in liquid nitrogen and milled in an ultracentrigal mi. The comminuted material was immediately weighed into a headspace vial and sealed gas-tight with a septum. After 90 min of thermostatting at 150° C. in the headspace sampler, an aliquot of gas at a known pressure was injected onto the GC column.

The following procedure was used to synthesize the polyesters:
In a 200L-alloyed steel reactor were preplaced a suspension of 60.675 kg terephthalic and 1.44 kg isophthalic acid in 31.6 kg ethylene glycol. While stirring, add to this reaction mixture the appropriate amount of antimony triacetate, 8.125 g cobalt acetate tetrahydrate in 1000 g ethylene glycol and 34.65 g tetramethylammonium hydroxide in 500 g ethylene glycol. The sealed reactor was heated to 272° C. The slow depressurization of the pressurized container began at 2.8 bar. After approx. 20 min, the heterogeneous catalyst in 500 g ethylene glycol and 4 g Irgafos P-EPQ as glycolic solution were added, at normal pressure.

Liquid phase polymerization was next started, by slowly applying a vacuum. After approx. 60 min the final vacuum of approx. 4 mbar was attained. The end of the reaction was indicated by achieving a defined torque.

The reaction vessel was depressurized with nitrogen and the reactor was emptied into a water bath through various nozzles, over a period of approx. 60 minutes. The product strands were granulated immediately.

Table 1 shows an overview of the reaction times of the liquid phase polycondensation.

TABLE 1
Reaction time and viscosity in liquid phase polycondensation as a function of the catalyst system used

| | | heterogeneous | Reaction | Viscosity number | intrinsic |
|---|---|---|---|---|---|
| | Catalyst | catalyst | time | per DIN ISO | viscosity |
| Experiment No. | (ppm) | (ppm) | (min) | 1628/5 (ml/g) | (dl/g)³⁾ |
| 1 (Comparison example) | Antimony acetate (640)¹⁾ | 0 | 185 | 74.2 | 0.643 |
| 2 (Implementation example) | Antimony acetate (640)¹⁾ | Hydrotalcite Pural Mg 61 HT⁴⁾ (50) | 90 | 78.9 | 0.68 |
| 3 (Implementation examplel) | Antimony acetate (640)¹⁾ | Hydrotalcite Pural Mg 61 HT (25) | 93 | 77.9 | 0.672 |
| 4 (Implementation example) | Antimony acetate (640)¹⁾ | Hydrotalcite Pural Mg 61 HT (10) | 95 | 75.4 | 0.661 |
| 5 (Implementation example) | Antimony acetate (490)²⁾ | Hydrotalcite Pural Mg 61 HT (50) | 90 | 80.2 | 0.69 |

¹⁾corresponds to a concentration of approx. 260 ppm antimony in the polyester
²⁾corresponds to a concentration of approx. 200 ppm antimony in the polyester
³⁾in o-chlorophenol
⁴⁾Trade name of the SASOL company

Table 1 clearly shows that even the smallest additions of the heterogeneous component are able to markedly increase the polycondensation rate in the melt phase.

If the polyester is to be used to package foods, then the polycondensation reaction in liquid phase is followed by a so-called solid-state polycondensation. The purpose of this procedural step is to drastically reduce the byproducts formed during the melt phase polycondensation—such as acetaldehyde—and simultaneously increase the intrinsic viscosity. The viscosity increase is necessary to achieve the desired mechanical properties in the end product. This reaction is performed at temperatures of 180-230° C. The procedural step is especially cost-intensive because of the need to use pure nitrogen as process gas.

The solid-state polycondensation occurs according to the procedure described below. The solid-state reaction was performed in a laboratory glass reactor of the BÜHLER Co., in a pulsating fluidized bed. 3 kg amorphous PET pellets were placed in the reactor preheated to 150° C. The volume flow of the process gas (nitrogen) flowing through the PET was of 125 Nm³/h. Approx. 15 m³/h nitrogen were removed from the circulation through a removal loop and replaced with network nitrogen. The crystallization and drying of the PET was performed at 170° C. over a period of 2.5 h following the addition of the amorphous PET pellets. The solid-state reaction occurred next over a period of 6 h, at a temperature of 210° C. and at the parameters mentioned (volume flow, amount removed). 50 g samples were taken at regular intervals and without affecting the process parameters.

Table 2 below shows the values of intrinsic viscosity obtained during the solid state polycondensation of polyesters with various catalyst systems.

TABLE 2
SSP rate as a function of the catalyst system

| | Catalyst | SSP time | ΔIV |
|---|---|---|---|
| Experiment No. | system | (h) | (dl/g) |
| 1 (Comparison example) | 260 ppm Sb | 0 | 0 |
| | | 2 | 0.058 |
| | | 4 | 0.116 |
| | | 7 | 0.173 |
| 2 (Implementation example) | 200 ppm | 0 | 0 |
| | Sb/50 ppm HT/ | 1.75 | 0.061 |
| | 100 ppm P-EPQ | 3 | 0.112 |
| | | 4.75 | 0.163 |
| | | 6 | 0.202 |
| 3 (Implementation example) | 260 ppm | 0 | 0 |
| | Sb/25 ppm HT/ | 1.75 | 0.079 |
| | 150 ppm P-EPQ | 3 | 0.125 |
| | | 4.75 | 0.166 |
| | | 6 | 0.204 |
| 4 (Implementation example | 260 ppm | 0 | 0 |
| | Sb/50 ppm HT/ | 1.75 | 0.068 |
| | 100 ppm P-EPQ | 3 | 0.115 |
| | | 4.75 | 0.18 |
| | | 6 | 0.215 |

Table 2 illustrates the significant effect of the catalyst system according to the invention on the reaction rate in solid-state polycondensation.

1. Catalyst systems for the synthesis of polyesters, for instance for the manufacture of polyethylene terephthalate and its copolyesters, consisting of
a) an antimony, germanium or titanium compound
b) a heterogeneous catalyst and
c) optionally a stabilizer.

2. Catalyst systems for polycondensation reactions according to claim 1, characterized by the antimony or germanium compound used being antimony acetate, antimony oxide, antimony glycolate, germanium oxide or tetrabutyl titanate.

3. Catalyst systems for polycondensation reactions according to claim 1, characterized by the heterogeneous catalyst used being hydrotalcites of general formula [M(II)₁₋ₓM(III)ₓ(OH)2]^{x+(A}ⁿ⁻_{x/n}).mH₂O, in which M(II) are divalent metals, in particular magnesium, zinc, nickel, copper, iron(III) or cobalt(II); M(III) are trivalent metals, for instance aluminum or iron(III) and A are anions, for instance carbonate, borate or titanyl compounds.

4. Catalyst systems for polycondensation reactions according to claim 1, characterized by the stabilizers used being esters of phosphoric acid or of phosphorous or phosphonic acids.

5. Catalyst systems for polycondensation reactions according to claim 1, characterized by using 50-1000 ppm antimony or germanium compound, 1-100 ppm heterogeneous catalyst and 5-500 ppm stabilizer.

6. Catalyst systems for polycondensation reactions according to claim 1, characterized by the heterogeneous catalyst fraction having a particle size of 50-100 nm.

7. Catalyst systems for polycondensation reactions according to claim 1, characterized by the ratio of homogeneous to heterogeneous catalyst fractions being of 100:1 to 1:5.

8. Catalyst systems for polycondensation reactions according to claim 7, characterized by the ratio of homogeneous to heterogeneous catalyst fractions being of 80:1 to 5:1.

9. Utilization of polyethylene terephthalate produced according to the claims above for the manufacture of bottles, sheets and fibers.
